(19) United States
(12) Patent Application Publication
(10) Pub. No.: US 2003/0108699 A1
(43) Pub. Date: Jun. 12, 2003

(54) Air bag used as a cushion in a package

(76) Inventor: Kazuya Tanaka, Tenri-Shi (JP)

Correspondence Address: Platon N. Mandros, BURNS, DOANE, SWECKER & MATHIS, L.L.P., P.O. Box 1404, Alexandria, VA, 22313-1404, US

(21) Appl. No.: 10/095,517

(22) Filed: Mar. 13, 2002

(30) Foreign Application Priority Data
Dec. 10, 2001 (JP) 2001-376312

(51) Int. Cl. B32B 1/02; B60R 21/16

(52) U.S. Cl. 428/35.2; 280/728.1

(57) ABSTRACT

An air bag which has a bag body which has a plurality of chambers with respective check valves, an air passage which is located on an upper portion of the body and which communicates with the check valves, and an inlet part which is fitted in the air passage. The inlet part is a double-folded plastic film and is fitted between a front film and a back film which compose the bag body and the air passage. An injection nozzle is inserted in the inlet part. When the tip of the nozzle comes in contact with the turnaround portion of the double-folded film, the injection nozzle automatically blows out air, and the air flows from the air passage into the chambers through the check valves.

### BACKGROUND OF THE INVENTION

1. Filed of the Invention

The present invention relates to an air bag, and more particularly to an air bag which comprises a plurality of chambers parted from each other by plastic films and which is used as a cushion in a package.

2. Description of Related Art

An air bag disclosed by Japanese Patent Laid Open Publication No. 1-164142 has been used as a cushion in a package. As FIGS. 10 and 11 show, this conventional air bag comprises a flat air passage 3 and a plurality of chambers 1 parted from each other by plastic films. At an end of the air passage 3, an air inlet 4 is provided, and the other end of the passage 3 is closed. On the side of the chambers 1 along the direction of air flow in the air passage 3 shown by arrow “A”, check valves 2 made of plastic films are provided for the respective chambers 1. In order to produce this air bag, a front film and a back film are joined together by fusing the films at the shadowed parts in FIG. 10. The chambers 1 communicate with the air passage 3 only via the respective check valves 2.

Generally, as cushions or protectors for packed electric appliances such as personal computers, coolite is used. This causes a problem that a large amount of refuse comes out after unpacking, and there is a strong demand to use such a plastic air bag as protectors for packed products.

In injecting air into the above-described air bag, as FIG. 11 shows, a spool 5 made of hard plastic is put in the inlet 4 of the air passage 3 so as to serve as a receiver of an air nozzle. This setting of the spool 5 is carried out after the air bag is produced, which causes a problem that the number of processes increases.

Also, while the air bag is made of films and is flat, the spool 5 is voluminous and hard. Therefore, the spool 5 may cause damage to other air bags, and when this air bag is used as a cushion in a package, it may cause damage to the packed product.

### SUMMARY OF THE INVENTION

An object of the present invention is to provide an air bag which does not have a voluminous air inlet part and which does not cause damage to other bags and the packed product.

Another object of the present invention is to provide an air bag to which an air inlet part can be automatically fitted during a manufacturing process.

Another object of the present invention is to provide an air bag to which air injection is easy and efficient.

Further, another object of the present invention is to provide an air bag which has a removable air inlet part of which protruding portion can be cut off after air injection.

In order to attain the objects, an air bag according to the first invention comprises: a bag body which comprises a plurality of plastic air chambers provided with check valves respectively, the chambers being arranged in such a way that the check valves of the respective chambers are in an array; an air passage which extends along the array of the check valves, the air passage being formed by fusing a front film and a back film in such a way that the air passage communicates with the check valves; and an inlet part which is fitted in the air passage so as to permit insertion of an injection nozzle into the air passage. In the air bag, the inlet part is a double plastic film and has a closed bottom, and the inlet part is fitted in the air passage in such a way that the bottom of the inlet part is between the front film and the back film of the air passage and that a part of the inlet part protrudes from the air passage.

In the air bag according to the first invention, the inlet part is made of a plastic film and accordingly flat, while a conventional spool is voluminous. Therefore, this bag will never cause damage to other bags and the packed product. Also, because a part of the inlet part sticks out, the worker can easily recognize the inlet part.

If the inlet part is designed to be substantially vertical to the air passage, the inlet part can be fitted in the air passage during a manufacturing process of the air bag body. Specifically, the bag body and the air passage are usually produced integrally, and during the process, the double plastic film with a closed bottom is inserted between the front film and the back film composing the air passage. Thus, it is not necessary to attach the inlet part to the bag body after production of the bag body, and the productivity becomes higher.

The injection nozzle is of a type which automatically blows out air when the tip of the nozzle comes into contact with something. As mentioned, the closed bottom of the inlet part is located in the air passage, and when the tip of the nozzle comes into contact with the bottom of the inlet part, the nozzle automatically blows out air. Therefore, the worker can execute the air injection process without worrying about the amount of insertion of the nozzle, which is easy and efficient. The closed bottom of the inlet part serves as a stopper of the nozzle and also prevents damage to the air passage which may be caused by the tip of the nozzle.

In the air bag according to the first invention, the inlet part may be a double-folded film or may be composed of two films fused together at their lower sides. Preferably, the double film of the inlet part is fused in a middle portion at both sides, so that a guide for the injection nozzle is made. Because of the guide, the air injection process becomes more efficient.

An air bag according to the second invention comprises: a bag body which comprises a plurality of plastic air chambers provided with check valves respectively, the chambers being arranged in such a way that the check valves of the respective chambers are in an array; an air passage which extends along the array of the check valves, the air passage being formed by fusing a front film and a back film in such a way that the air passage communicates with the check valves; and an inlet part which is fitted in the air passage so as to permit insertion of an injection nozzle into the air passage. In this air bag, the inlet part is a stack of two sheets, each of which is a laminate sheet of at least two kinds of materials, and is fitted between the front film and the back film of the air passage in such a way that a part of the inlet part protrudes from the air passage. Also, each of the sheets composing the inlet part has an outer layer made of a material which is fusible with the front film and the back film and an inner layer made of a material which is infusible or does not fuse at a fusing temperature of the outer layer.

In this air bag, an injection nozzle is guided into the air passage by the inner layers of the two sheets of the inlet part.

The air bag according to the second invention is a simplified model of the air bag according to the first invention. Because the inlet part is a stack of two sheets, like in the air bag according to the first invention, the inlet part is not voluminous and will never cause damage to other bags and the packed product. Also, because a part of the inlet part sticks out, the worker can recognize the inlet part easily.

If the inlet part is designed to be substantially vertical to the air passage, the inlet part can be fitted in the air passage during a manufacturing process of the air bag body, and an inlet part fitting process after production of the bag body is not necessary. Thus, the productivity becomes higher.

If the inner layers of the sheets of the inlet part are fusible, fusion preventive layers shall be provided on the inner layers of the sheets.

Preferably, the sheets of the inlet part are laminate sheets of materials with mutually different shrinkage factors, and the two sheets are stacked in such a way to deflect away from each other. In this case, the entrance is open, and insertion of a nozzle in the inlet part is easy.

An air bag according to the third invention comprises: a bag body which comprises a plurality of plastic air chambers provided with check valves respectively, the chambers being arranged in such a way that the check valves of the respective chambers are in an array; an air passage which extends along the array of the check valves, the air passage being formed by fusing a front film and a back film in such a way that the air passage communicates with the check valves; and an inlet part which is fitted in the air passage so as to permit insertion of an injection nozzle into the air passage. In this air bag, the inlet part is a laminate sheet of at least two different materials and is fitted between the front film and the back film of the air passage in such a way that a part of the inlet part protrudes from the air passage, and the sheet composing the inlet part has a first layer made of a material which is fusible with the front film and the back film and a second layer made of a material which is infusible or does not fuse at a fusing temperature of the first layer.

If the inlet part is designed to be substantially vertical to the air passage, the inlet part can be fitted in the air passage during a manufacturing process of the air bag body, and an inlet part fitting process after production of the bag body is not necessary. Thus, the productivity becomes higher.

If the second layer of the sheet of the inlet part is fusible, a fusion preventive layer shall be provided on the second layer of the sheet.

Further, in either of the air bags according to the first, second and third inventions, the inlet part may have a cut, a slit or a score to make it easy to cut off the protruding portion of the inlet part. After air injection into the air bag is completed, the protruding portion of the inlet part is cut off, and because of the cut, slit or score, this cutting can be done easily. Then, the air bag no longer has unnecessary protrusions. This arrangement is especially effective to small air bags.

In either of the air bags according to the first, second and third inventions, the bag body and the air passage are preferably made of a front film and a back film. Specifically, a front film and a back film are stacked with a film for the check valves in-between, and while the stack of the films are being fed, necessary portions are subjected to a fusing treatment. Thereby, a plurality of chambers arranged side by side are formed, and simultaneously the air passage is formed. During this process, when the air passage is formed by fusion, the inlet part is fitted.

### BRIEF DESCRIPTION OF THE DRAWINGS

These and other objects and features of the present invention will be apparent from the following description with reference to the accompanying drawings, in which:

FIG. 1 is a plan view of an air bag which is a first embodiment of the present invention;

FIG. 2 is a perspective view which shows an inlet part and a state where the inlet part is fitted in the air bag;

FIGS. 3a, 3b and 3c show the inlet part, FIG. 3a being a side view, FIG. 3b being a front view and FIG. 3c being a side view of a modification of the inlet part;

FIG. 4 is a perspective view which shows a state where an injection nozzle is inserted in the inlet part;

FIG. 5 is a sectional view of the bag body and the inlet part;

FIG. 6 is a perspective view which schematically shows a manufacturing process of the air bag;

FIGS. 7a, 7b and 7c show a way of supplying a film which is formed into inlet parts, FIG. 7a being a plan view, FIG. 7b being a sectional view cut along the line B-B and FIG. 7c being a sectional view cut along the line C-C;

FIG. 8 is a perspective view of a second embodiment of the present invention;

FIG. 9 is a perspective view of a third embodiment of the present invention;

FIG. 10 is a plan view of a conventional air bag; and

FIG. 11 is a perspective view of a spool which permits air injection into the conventional air bag.

### DETAILED DESCRIPTION OF THE PREFERRED EMBODIMENTS

Embodiments of an air bag according to the present invention will be described with reference to the accompanying drawings.

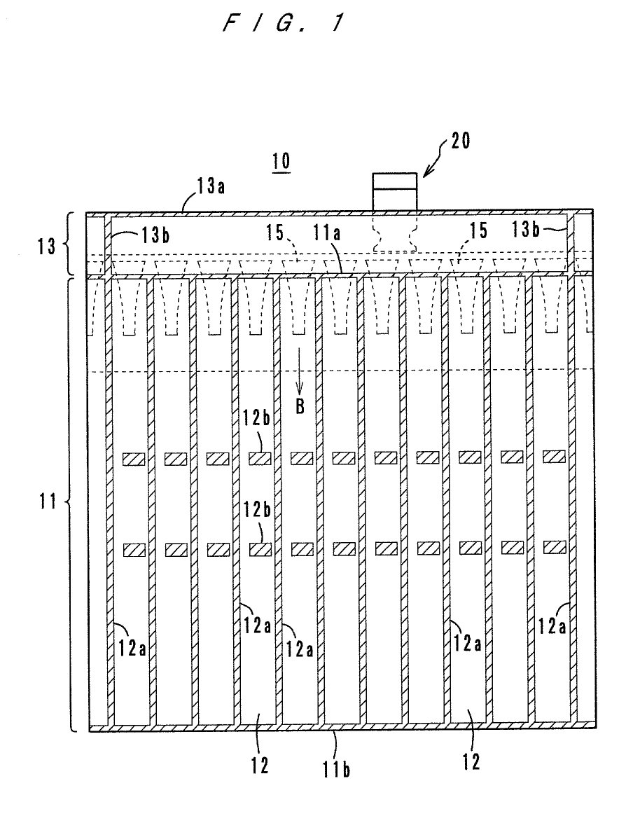

### First Embodiment; See FIGS. 1-7

FIG. 1 shows an air bag 10 which is a first embodiment of the present invention. This air bag 10 has a bag body 11 composed of vertical narrow chambers 12 which are parted from each other by fused portions 12a. The air bag 10 further comprises an air passage 13 which is provided along the upper side of the bag body 11, an air inlet part 20 inserted in the passage 13, and check valves 15 provided on the upper sides of the respective chambers 12.

The bag body 11 is made by fusing a front plastic film with a back plastic film at four sides (denoted by 11a and 11b in FIG. 1), and further by fusing at the portions 12a, mutually independent air chambers 12 are formed. Further fused portions 12b are formed in each of the chambers 12, and thereby, the bag body 11 can be bent easily, so that a product can be wrapped up the air bag 10.

The check valves 15 are provided for the respective chambers 12. As FIG. 5 shows, each of the check valves 15 comprises two films 16a and fusion preventive layers 16b formed between the films 16a. In FIG. 1, air is supplied in the direction “B”, that is, supplied into each of the chambers 12 and prevented from flowing backward. The plastic check valves 15 of this type is well known (for example, disclosed by Japanese Patent Laid Open Publication Nos. 1-164142 and 7-10159), and the detailed description thereof is omitted.

The air passage 13 is formed by fusing the front film and the back film together at the upper portions (denoted by 13a and 13b). This passage 13 is an air chamber which extends along the array of the check valves 15. The air passage 13 is connected to the chambers 12 via the respective check valves 15, and air supplied to the air passage 13 is further supplied to the respective chambers 12.

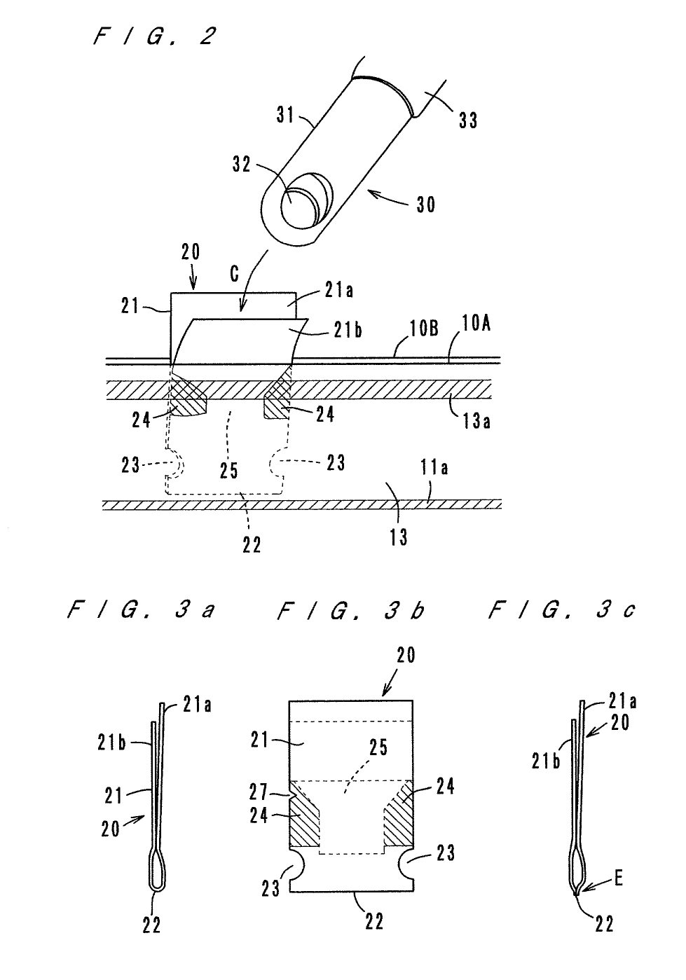

The inlet part 20 is substantially vertically fitted in the air passage 13. As FIGS. 2, 3a and 3b show, the inlet part 20 is made by folding a plastic film 21 in two. The inlet part 20 is inserted between the front film 10A and the back film 10B in such a way that its turnaround portion (closed bottom) 22 is positioned in between the films 10A and 10B and that its flaps 21a and 21b protrude from the films 10A and 10B. Semicircular holes 23 may be made in the turnaround portion 22 at the sides.

More specifically, the inlet part 20 is fused with the front film 10A and the back film 10B at the fused portion 13a. The double folded film 21 of the inlet part 20 is fused at both sides in its middle portion, and the middle portion between the fused portions 24 and 24 serves as a guide for an injection nozzle 30. The minimum inner circumference of the guide portion 25 is nearly equal to the outer circumference of the injection nozzle 30. In order to prevent the guide portion 25 from being fused when carrying out fusion of the portion 13a, a fusion preventive layer 26 is formed on the inner surface of the film 21. The fusion preventive layer 26 can be formed easily, for example by photogravuring heat resistant ink on the inner surface of the film 21.

Now, the structures and the materials of the films 10A, 10B and 21 are described. As FIG. 5 shows, the bag body films 10A and 10B are laminates of a non-heat-sealing film 101, such as nylon, PET, etc. and a heat sealing film 102 such as polyethylene, polypropylene, etc., and the heat-sealing film 102 is located inside.

The film 21 composing the inlet part 20 is a laminate of a heat-sealing film 211 such as polyethylene, polypropylene, etc., a polypropylene foam or a relatively thick film 212 such as PET, OPP, etc. and a heat-sealing film 213 such as polyethylene, polypropylene, etc. The outer film 213 must be fused with the bag body films 10A and 10B, and the inner film 211 must be fused at the portions 24 so as to make the guide portion 25. The intermediate film 212 is to secure appropriate stiffness for the inlet part 20 when the injection nozzle 30 is inserted therein.

The injection nozzle 30 is, as shown in FIG. 2, of a conventional type. A tip 31 freely sticks out of and retracts in a cylinder 33, and when the tip 31 comes into contact with something and slightly retracts, air blows out of a hole 32 automatically. One of the flaps of the inlet part 20 is long (21a), and the other flap is short (21b). By pushing out the longer flap 21a with the tip of the injection nozzle 30, the flaps 21a and 21b can be open aside easily, and subsequently the nozzle 30 can be inserted in the direction “C”.

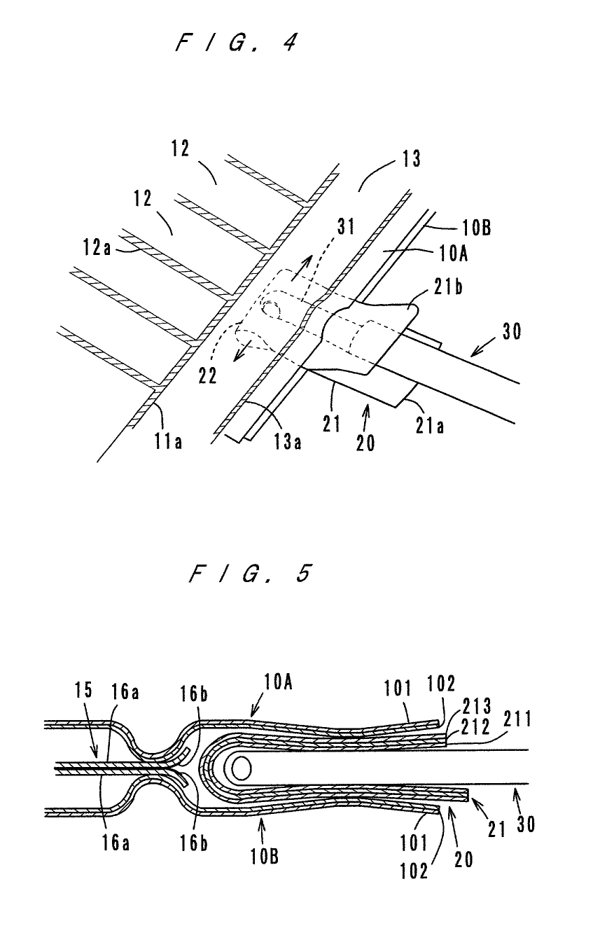

Thereafter, as FIG. 4 shows, when the tip of the nozzle 30 comes into contact with the turnaround portion 22, the tip 31 retracts, and air comes out automatically. The air is guided into the air passage 13 via the both sides of the inlet part 20, and while the air flows along the passage 13, the air comes into the chambers 12 through the check valves 15. The air injected into the chambers 12 never flows backward because of the check valves 15.

As shown in FIG. 3b, the inlet part 20 has a cut, a slit or a score 27 at least at one side of the film 21. This cut, slit or score 27 makes it easier to cut off the flaps after the above-described air injection is completed. The cut, slit or score 27 is formed at a position outside the fused portion 13a.

Once air injection is completed, the inlet part 20 is no longer necessary. By cutting off the flaps which protrude from the films 10A and 10B, the inlet part 20 will never be an obstacle. Especially when this air bag is a small one which is to be used as a cushion in a package of a small product such as a mobile telephone, it is preferred to cut off the flaps of the inlet part 20.

Various modifications of the inlet part 20 are possible. For example, instead of folding a film 21 in two, as FIG. 3c shows, two films 21a and 21b may be fused together at the bottom (denoted by E) to make a closed bottom 22.

It is possible to omit the fused portion 24. In this case, the width of the film 21 is nearly a half of the outer circumference of the injection nozzle 30, and the whole width of the film 21 serves as a guide for the nozzle 30.

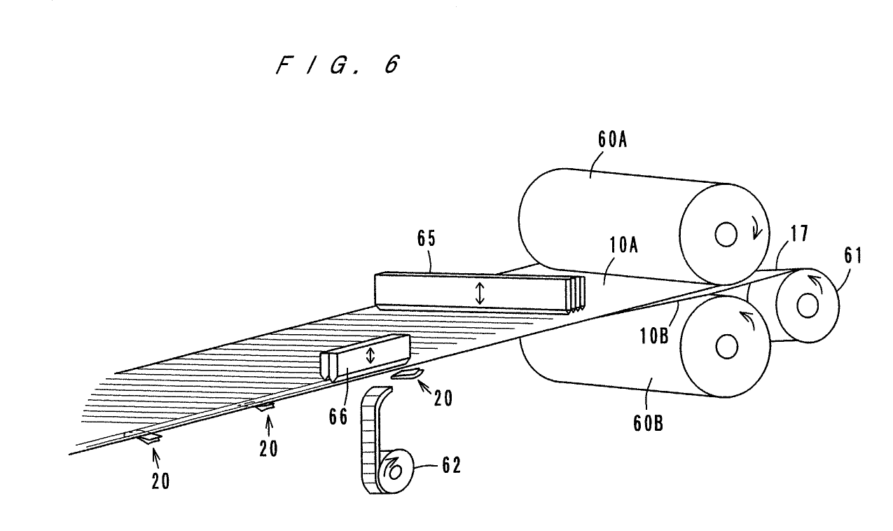

Next, a manufacturing process of the air bag 10 is briefly described. As FIG. 6 shows, bag body films 10A and 10B are unrolled respectively from rolls 60A and 60B, and simultaneously, a film 17 which contains the check valves 15 is unrolled from a roll 61 and is inserted between the films 10A and 10B.

A heated bar 65 is pressed onto the stack of the films 10A, 17 and 10B, and thereby, the fused portions 12a are formed. Thus, the chambers 12 with check valves 15 respectively are formed. Thereafter, the inlet part 20 is inserted between the films 10A and 10B, and the fused portions 11a and 13a are formed by a heated bar 66. Thereby, the inlet part 20 is fitted, and the air passage 13 is formed.

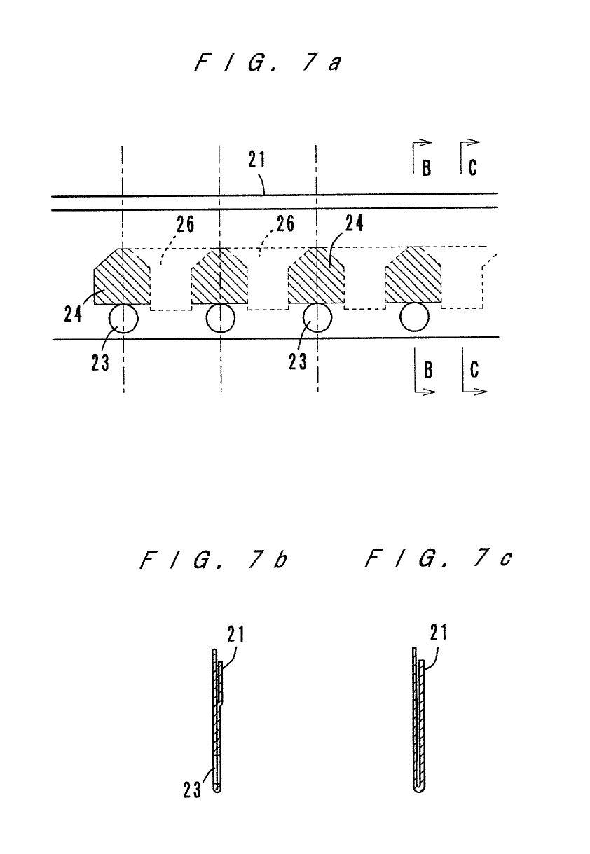

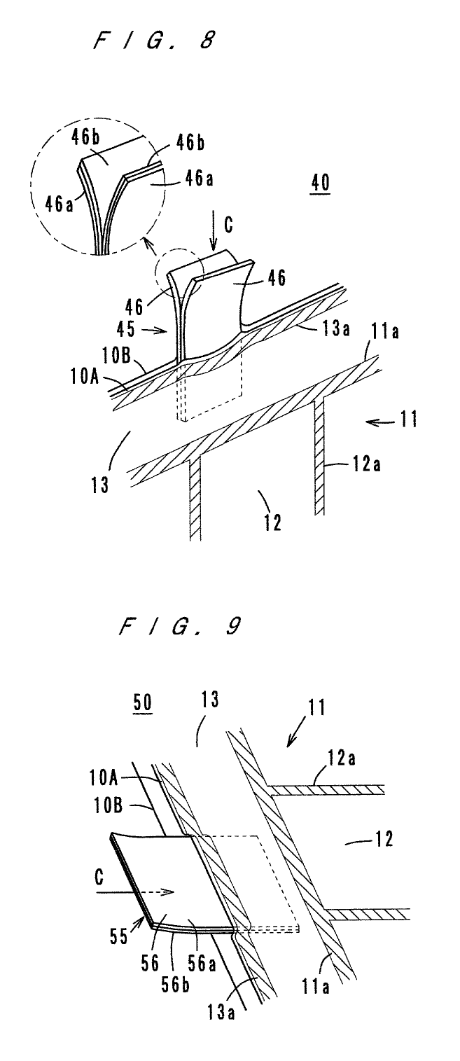

FIGS. 7a, 7b and 7c show a film 21 for the inlet parts 20. On a long film 21, the fusion preventive agent 26 is coated in positions at specified uniform intervals, and the film 21 is folded in two. On the folded film 21, the fused portions 24 and the holes 23 are formed in positions at specified uniform intervals. This film 21 is rolled into a roll 62, and the roll 62 is set as shown in FIG. 6. The film 21 is unrolled from the roll 62 and sent to a specified position, where a piece which functions as the inlet part 20 is cut off from the film 21, and the inlet part 20 is inserted and fused between the films 10A and 10B.

The other fused portions of the bag body, that is, the fused portions 11b, 12b and 13b are formed in a process after the process shown by FIG. 6, and at the last stage, the stack of the films is cut into a specified number of air bags 10 with chambers 12 (see FIG. 1).

The air bag 10 which is produced in the above-described way can be used in various ways. For example, the air bag 10 is folded by using the fused portions 12b as turnarounds, and a product can be put in the space enclosed by the folded bag 10. Also, after folding the air bag 10 in two by using the fused portions 12b as turnarounds, the sides of the bag 10 may be fused together. In this case, the air bag 10 can be used as a bag which has a cushioning function itself.

### Second Embodiment; See FIG. 8

In the second embodiment, instead of the inlet part 20, another inlet part 45 is fitted in the air passage 13. FIG. 8 shows the inlet part 45 provided in an air bag 40 which is the second embodiment of the present invention. The air bag 40 of the second embodiment has the same bag body 11 and the same air passage 13 as in the first embodiment, and the description of these parts is omitted.

This inlet part 45 is structured by inserting two sheets 46 between the bag body films 10A and 10B and fusing the films 46 with the bag body films 10A and 10B at the portion 13a. The sheets 46 are laminates of two or more kinds of materials with mutually different shrinkage factors. For example, the sheets 46 are laminate sheets of nylon and polyethylene or laminate sheets of paper and polyethylene. The usage of laminates of materials with mutually different properties is to cause deflection on each of the sheets 46. The sheets 46 are stacked together in such a way to deflect away from each other.

Thus, the inlet part 45 is fitted in such a way that the two sheets 46 are open outward, and therefore, an injection nozzle can be inserted in the inlet part 45 easily. The width of the sheets 46 is nearly equal to a half of the outer circumference of the nozzle.

It is not indispensable to use laminates of materials with mutually different shrinkage factors for the inlet part 45 so as to cause deflection of the sheets 46. It is, however, necessary that the outer material 46a of each sheet 46 is heat-sealing, and it is preferred that the inner material 46b of each sheet 46 is not heat-sealing. If a heat-sealing material is used as the inner material 46b, a fusion preventive layer must be formed.

In the air bag 40, the injection nozzle comes in the air passage 13 guided by the inner materials 46b of the sheets 46. Because the bottom of the inlet part 45 is open, also an injection nozzle which blows out air from its end can be used.

This air bag 40 of the second embodiment is, like the air bag of the first embodiment, produced in the manufacturing process shown by FIG. 6. In the manufacturing process, instead of the inlet parts 20, the inlet parts 45 are inserted and fused between the bag body films 10A and 10B.

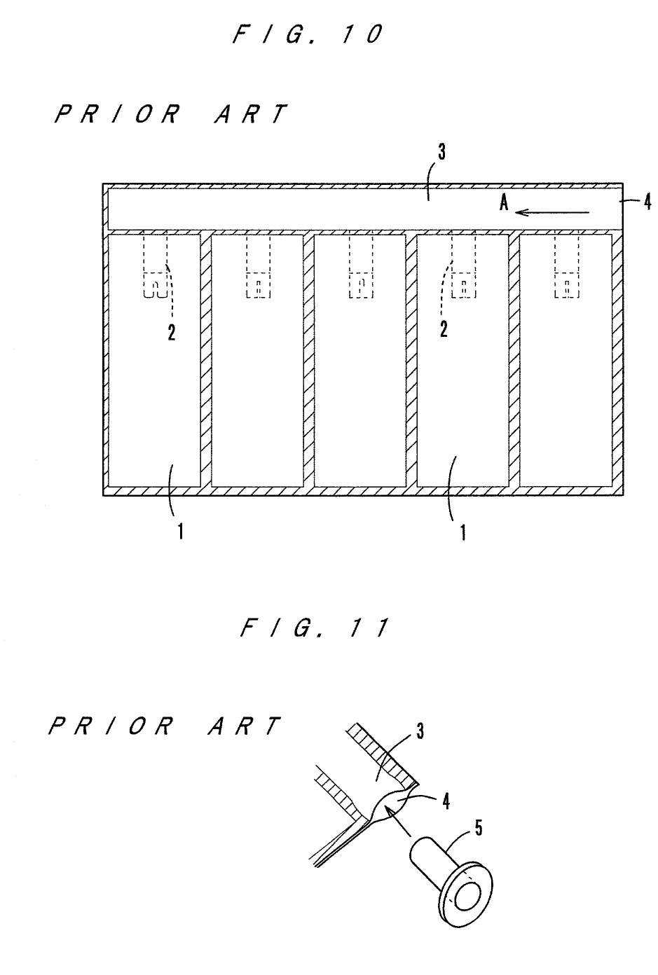

### Third Embodiment; See FIG. 9

In an air bag 50 of the third embodiment, instead of the inlet parts 20 and 45, an inlet part 55 shown by FIG. 9 is fitted in the air passage 13. The bag body 11 and the air passage 13 are the same structures as those in the first embodiment, and the description of these parts is omitted.

The inlet part 55 is structured by inserting a sheet 56 between the bag body films 10A and 10B and fusing the sheet 56 with the film 10A at the portion 13a. The sheet 56 is a laminate of two kinds of materials 56a and 56b. The material 56a is fusible with the film 10A (for example, polyethylene), and the material 56b is not fusible with the film 10A (for example paper). If the material 56b is heat-sealing, a fusion preventive layer must be formed thereon.

In the third embodiment, the sheet 56 of the inlet part 55 is not fused with the film 10B, and a hole is made. An injection nozzle is inserted in the hole in the direction “C”, and air is supplied into the air passage 13. The width of the sheet 56 is nearly equal to a half of the outer circumference of the injection nozzle. In the third embodiment, also, an injection nozzle which blows out air from its end can be used.

Like the air bags of the first and second embodiments, the air bag 50 of the third embodiment is produced by the manufacturing process shown by FIG. 6. Instead of the inlet parts 20 and 45, the inlet parts 55 are inserted and fused between the bag body films 10A and 10B.

### OTHER EMBODIMENTS

The materials of the bag body and the inlet part can be arbitrarily selected, and various combinations of these materials are possible. For example, instead of the laminate films described in the embodiments above, it is possible to use a film which has been subjected to a coating treatment which has the same effect as a laminate treatment and a film which has co-extruded two layers or three layers with mutually different properties.

Further, the number of chambers and the shape of the entire air bag can be designed arbitrarily. The inlet part can be fitted in the air passage not only at a position to set the inlet part substantially vertically to the air passage but also at an end of the air passage, that is, at a position corresponding to the inlet 4 of the air passage 3 shown in FIGS. 10 and 11 which show prior art.

Although the present invention has been described in connection with the preferred embodiments above, it is to be noted that various changes and modifications are possible to those who are skilled in the art. Such changes and modifications are to be understood as being within the scope of the present invention.

What is claimed is:

1. An air bag comprising:
a bag body which comprises a plurality of plastic air chambers provided with check valves respectively, the chambers being arranged in such a way that the check valves of the respective chambers are in an array;
an air passage which extends along the array of the check valves, the air passage being formed by fusing a front film and a back film in such a way that the air passage communicates with the check valves; and
an inlet part which is fitted in the air passage so as to permit insertion of an injection nozzle into the air passage;
wherein:
the inlet part is a double plastic film and has a closed bottom; and
the inlet part is fitted in the air passage in such a way that the bottom of the inlet part is between the front film and the back film of the air passage and that a part of the inlet part protrudes from the air passage.

2. An air bag according to claim 1, wherein the inlet part is a plastic film which is folded in two at the bottom.

3. An air bag according to claim 1, wherein the inlet part is composed of two films fused together at their lower ends.

4. An air bag according to claim 1, wherein the inlet part has a middle portion where a guide for the injection nozzle is made by fusing the double film in a middle portion at both sides.

5. An air bag according to claim 1, wherein the inlet part is fitted in the air passage to be substantially vertical to the air passage.

6. An air bag according to claim 1, wherein the inlet part has a cut, a slit or a score which makes it easy to cut off the protruding portion of the inlet part.

7. An air bag comprising:
a bag body which comprises a plurality of plastic air chambers provided with check valves respectively, the chambers being arranged in such a way that the check valves of the respective chambers are in an array;
an air passage which extends along the array of the check valves, the air passage being formed by fusing a front film and a back film in such a way that the air passage communicates with the check valves; and
an inlet part which is fitted in the air passage so as to permit insertion of an injection nozzle into the air passage;
wherein:
the inlet part is a stack of two sheets, each of which is a laminate sheet of at least two kinds of materials, and is fitted between the front film and the back film of the air passage in such a way that a part of the inlet part protrudes from the air passage; and
each of the sheets composing the inlet part has an outer layer made of a material which is fusible with the front film and the back film and an inner layer made of a material which is infusible or does not fuse at a fusing temperature of the outer layer.

8. An air bag according to claim 7, wherein:
each of the sheets composing the inlet part is a laminate sheet of materials with mutually different shrinkage factors; and
the two laminate sheets are stacked in such a way to deflect away from each other.

9. An air bag according to claim 7, wherein the inlet part is fitted in the air passage to be substantially vertical to the air passage.

10. An air bag according to claim 7, wherein the inlet part has a cut, a slit or a score which makes it easy to cut off the protruding portion of the inlet part.

11. An air bag comprising:
a bag body which comprises a plurality of plastic air chambers provided with check valves respectively, the chambers being arranged in such a way that the check valves of the respective chambers are in an array;
an air passage which extends along the array of the check valves, the air passage being formed by fusing a front film and a back film in such a way that the air passage communicates with the check valves; and
an inlet part which is fitted in the air passage so as to permit insertion of an injection nozzle into the air passage;
wherein:
the inlet part is a laminate sheet of at least two different materials and is fitted between the front film and the back film of the air passage in such a way that a part of the inlet part protrudes from the air passage; and
the sheet composing the inlet part has a first layer made of a material which is fusible with the front film and the back film and a second layer made of a material which is infusible or does not fuse at a fusing temperature of the first layer.

12. An air bag according to claim 11, wherein the inlet part is fitted in the air passage to be substantially vertical to the air passage.

13. An air bag according to claim 11, wherein the inlet part has a cut, a slit or a score which makes it easy to cut off the protruding portion of the inlet part.
